(19) United States
(12) Patent Application Publication
(10) Pub. No.: US 2025/0087990 A1
(43) Pub. Date: Mar. 13, 2025

(54) TRANSFORMER PROTECTION SYSTEM USING DIRECT CURRENT SWITCH CIRCUIT

(71) Applicant: TechHold, LLC, Minneapolis, MN (US)

(72) Inventors: GEORGE ANDERSON, Champlin, MN (US); GREG FUCHS, River Falls, WI (US); DAVID ANDERSON, Excelsior, MN (US); WALLACE JENSEN, Centerville, MN (US)

(73) Assignee: TechHold, LLC, Minneapolis, MN (US)

(21) Appl. No.: 18/883,539

(22) Filed: Sep. 12, 2024

Related U.S. Application Data
(60) Provisional application No. 63/582,376, filed on Sep. 13, 2023.

(51) Int. Cl. H02H 7/04; H02H 3/16; H02H 3/52; H02H 9/02; H02H 9/06

(52) U.S. Cl. CPC H02H 7/04; H02H 3/16; H02H 3/52; H02H 9/02; H02H 9/06

(57) ABSTRACT

A protection circuit may be electrically connected to a transformer neutral of a power grid transformer. The protection circuit may include a direct current (DC) blocking component electrically connected between the transformer neutral and a ground connection, as well as a direct current switch assembly positioned in parallel with the direct current blocking component between the transformer neutral and the ground connection. The direct current switch assembly includes at least one direct current switch having a switching element that is electrically controllable between a closed position and an open position. In some examples, a conductive housing encloses one or more switching elements. The conductive housing is electrically isolated from the ground connection. In further examples, one or more direct current switches may be electrically connected in series to provide greater voltage withstand and safety due to operational redundancy.

### CROSS-REFERENCE TO RELATED APPLICATIONS

The present application claims priority from U.S. Provisional Patent Application No. 63/582,376, filed on Sep. 13, 2023, the disclosure of which is hereby incorporated by reference in its entirety.

### BACKGROUND

Power grid transformers operate at high voltage and high current, and typically are exposed to multiple phases of alternating current carried on power lines connected thereto. In some instances, such as in the case of solar storms and the like, there may be slowly varying direct currents or quasi-DC currents induced in the ground and in the power lines above the ground. When experienced at multi-phase transformers attached to those power lines, a neutral connection of the transformer may deviate from a neutral or ground voltage. If the induced current is large enough, and if the transformer neutral is not connected to ground, a significant direct current voltage may appear at the transformer neutral.

To address this issue, existing systems have attempted to maintain a ground connection to the transformer neutral, thereby discharging any induced current effects. However, with significantly large induced currents, the connection of the transformer neutral to ground may cause damage due to high current passing from the transformer neutral to the ground in the event of induced DC current on the power grid lines.

An example solution to the above issues is described in U.S. Pat. No. 8,878,396. In that example solution, a pair of switches, including a low voltage, direct current switch and a high voltage, alternating current switch, are connected in series between a transformer neutral and ground. This set of switches may be actuated in sequence to ensure proper operation of the circuit. That is, first the low voltage direct current switch will open, followed by opening of the higher voltage, alternating current switch. This allows for the higher voltage rating of the alternating current switch to maintain the switch assembly in an open state, since an alternating current switch generally may be obtained that has a high voltage rating. The direct current switch, on the other hand, may be faster-acting and may be better able to safely break a high DC current flow, but may have a lower voltage rating, meaning that it may fail at very high voltages experienced over a prolonged period of time.

Such a system has a number of advantages, in terms of its responsiveness to a variety of types of conditions experienced at the transformer neutral. However, construction of such a circuit may be complex and expensive. For example, typically direct current switches and alternating current switches may be sourced from different suppliers, and alternating current switches may not be available. Additionally, while direct-current switches are typically more compact and easily integrable into a circuit solution, alternating current switches may be larger or of various complex shapes. Still further, the above described solution requires a particular sequencing of actuation of the direct current and alternating current switches, which is subject to responsiveness characteristics of those switches.

### SUMMARY

Generally speaking, the present disclosure is directed to a protection circuit usable to protect a multi-phase transformer, such as a powerline transformer, from damage due to direct current or DC voltage that may otherwise be experienced at the transformer neutral and which may cause damage to the transformer. In example aspects, one or more direct current switches may be electrically connected between a transformer neutral and a ground. A housing of at least one of the one or more direct current switches may be isolated from ground, thereby avoiding a large voltage difference between a high-voltage side of the direct current switches and the housing which may otherwise experience arcing effects, and therefore potential failure.

In some aspects, for example in versions utilizing two or more such direct current switches, each of those switches could be actuatable to open concurrently. In versions of such a circuit utilizing at least one direct current switch, the switch may be selected to be actuatable across a wide range of operating conditions. Furthermore, in such aspects, one or more, and sometimes all, of the direct current switches may have housings that are isolated from ground.

In a first aspect, a protection circuit is disclosed. The protection circuit is electrically connected to a transformer neutral of a power grid transformer, and includes a direct current (DC) blocking component electrically connected between the transformer neutral and a ground connection. The protection circuit further includes a direct current switch assembly positioned in parallel with the direct current blocking component between the transformer neutral and the ground connection, the direct current switch assembly including at least one direct current switch having a switching element enclosed by a conductive housing, the switching element being electrically controllable between a closed position and an open position. The conductive housing is electrically isolated from the ground connection.

In a second aspect, a protection circuit electrically connectable between a transformer neutral of a power grid transformer and a ground connection is disclosed. The protection circuit includes a direct current (DC) blocking component electrically connectable between the transformer neutral and the ground connection. The protection circuit further includes a direct current switch assembly electrically connectable in parallel with the direct current blocking component, the direct current switch assembly including a plurality of direct current switches operatively connected in series with each other, each of the plurality of direct current switches having a switching element, the switching element of each of the plurality of direct current switches being electrically controllable between a closed position and an open position.

In some examples, a conductive housing may be positioned to enclose one or more direct current switches. The conductive housing of at least one of the plurality of direct current switches is electrically isolated from the ground connection.

### BRIEF DESCRIPTION OF THE DRAWINGS

FIG. 1 illustrates an example transformer protection circuit in accordance with an example embodiment of the present disclosure.

FIG. 2 illustrates an example transformer protection circuit in accordance with a further example embodiment of the present disclosure.

FIG. 2A illustrates an alternative of the example transformer protection circuit of FIG. 2.

FIG. 3 illustrates an example transformer protection circuit in accordance with a further embodiment of the present disclosure.

FIG. 4 illustrates an example transformer protection circuit in accordance with a further embodiment of the present disclosure.

FIG. 5 illustrates an example transformer protection circuit in accordance with a further embodiment of the present disclosure.

### DETAILED DESCRIPTION

As briefly described above, embodiments of the present invention are directed to a protection circuit usable to protect a multi-phase transformer, such as a powerline transformer, from damage due to direct current or DC voltage that may otherwise be experienced at the transformer neutral and which may cause damage to the transformer. In example aspects, one or more direct current switches may be electrically connected between a transformer neutral and a ground. A housing of at least one of the one or more direct current switches may be isolated from ground, thereby avoiding a large voltage difference between a high-voltage side of the direct current switch and the housing which may otherwise experience arcing effects, and therefore potential failure.

In particular, in circumstances where a direct current switch is typically in a closed position, whether a housing of the direct current switch is connected to ground or isolated from ground is generally of not significant relevance. However, if the direct current switch is in an open position, a grounded housing of that switch may result in a large voltage difference between a high voltage switch connection and the grounded housing. While the grounding of the housing of such a direct current switch is typically encouraged for safety purposes, it may be the case that this reduces the voltage that may otherwise be supportable across the switch contacts. In circumstances where safety concerns may otherwise be addressed, it may be advantageous to allow disconnection between the housing of the direct current switch and the ground. This may be accomplished, for example, by preventing access to or contact to a housing of a direct current switch by maintenance personnel when the direct current switch is in an open position, by using other switching mechanisms to selectively ground the housing of the direct current switch, or other methods.

In some examples, two or more direct current switches may be utilized. The direct current switches may be connected in series. One or more of those direct current switches may be isolated from ground, and in some instances, all of the direct current switches that are connected in series may be isolated from ground. In some instances, to isolate the direct current switches from ground, a large resistor may be connected between a housing of each switch and a ground connection. In other instances, there may be no electrical connection to the housing of each switch.

The use of a direct current switch in the context of the present disclosure ensures a fast acting switch can quickly open to prevent current from flowing from a transformer neutral to ground in the event of a large induced current at the transformer neutral. This mitigates the risk of damage to the transformer generally. However, typically direct current switches have a voltage limit at which they may fail. It has been determined that a first failure mode of a direct current switch is an electrical are forming between a high voltage side of the direct current switch and a housing of the direct current switch. This is because a significant voltage differential appears between the high-voltage side of the direct current switch (e.g. connected to the transformer neutral) and the housing, which is typically connected to ground. Once the direct current switch opens in response to detection of current at the transformer neutral, the high voltage connection of the direct current switch is closer to a portion of the housing that is grounded than it is to the low voltage connection side of the direct current switches. Accordingly, it has been observed that arcing may occur at voltages above, e.g., 12-13 kV.

As discussed previously, existing solutions address this issue by introducing both a direct current switch and an alternating current circuit breaker in series within a protection circuit. However, alternating current circuit breakers are generally large, expensive, and awkward to integrate into such a circuit. Such alternating current circuit breakers do have the advantage of a higher voltage that can be withstood (e.g., typically up to about 27 kV or higher). In example implementations provided herein, by electrically isolating a housing of a direct current switch from the ground, the voltage withstand (e.g., voltage at which failure might occur) may be raised for such a direct current switch, beyond the rated limits of such a breaker. It has been observed that, after electrically isolating the housing of such an electrically-actuated switch from the ground, the voltage withstand limit (also referred to as a spark over level) for a direct current switch may instead be observed at, e.g., about 22 kV. Accordingly, for certain applications, it may be possible to eliminate the alternating current circuit breaker from such a protection circuit entirely. This has advantages in terms of cost, size, case of sourcing of components, and the like.

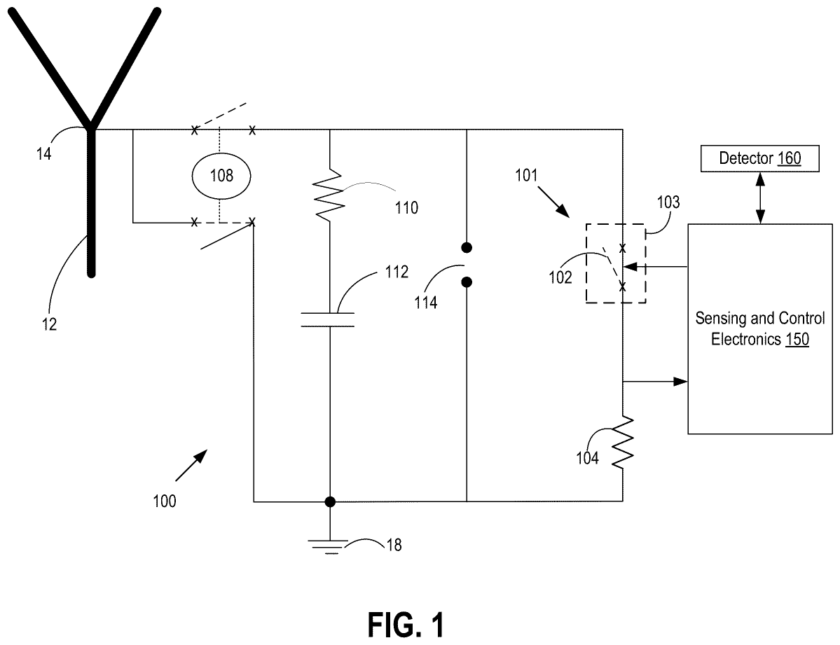

Referring now to FIGS. 1-4, various embodiments of example protection circuits are provided. FIG. 1 illustrates an example protection circuit 100 in accordance with an example embodiment of the present disclosure. The protection circuit 100 is electrically connected to a transformer 12, such as a powerline transformer. Specifically, the protection circuit 100 is electrically connected between a transformer neutral 14 of the transformer 12 and a ground connection 18.

In the example shown, the transformer neutral 14 is electrically connected to the protection circuit 100 via a manual switch 108, such as a Kirk key interlock maintenance switch. The manual switch 108 allows for manual connection or disconnection of the protection circuit 100 from the transformer 12, for example for maintenance purposes. The manual switch 108 toggles between a connected position in which the transformer neutral 14 is connected to the rest of the protection circuit 100, and a disconnected position in which the transformer neutral 14 is disconnected, and is instead bypassed directly to ground 18.

In the example shown, the protection circuit 100 includes a resistor 110 and a DC blocking component 112 electrically connected in series with each other between the transformer neutral 14 and the ground connection 18. Generally speaking, the DC blocking component 112 may be implemented as a capacitor or capacitor bank, in the example embodiments. The DC blocking component 112 may be used to block DC current between the transformer neutral 14 and ground connection 18, while allowing alternating current to continue to flow. The resistor 110 may be used to reduce or prevent ferro-resonances caused by a combination of the capacitor and transformer inductance. Detailed operation of such a DC blocking component 112 and resistor 110 is provided in U.S. Pat. No. 8,878,396, the disclosure of which is hereby incorporated by reference in its entirety.

In the example shown, the protection circuit 100 further includes an overvoltage protection device 114 electrically connected between the transformer neutral 14 and the ground connection 18 in parallel with the resistor 110 and DC blocking component 112. The overvoltage protection device 114 may be implemented, for example, as a spark gap or surge arrester. The overvoltage protection device 114 is configured to block current from flowing between the transformer neutral and the ground while the transformer neutral 14 remains below a predetermined, set voltage. Above the set voltage, the overvoltage protection device 114 may form an electrical connection, thereby allowing current to flow to the ground connection 18 from the transformer neutral 14. In the example in which the overvoltage protection device 114 is a spark gap, the set voltage may be selected by setting a gap width for the spark gap, above which a spark will form and current can flow. An example set voltage may be in the range of 6-15 kV, or as low as 4 kV. In some examples, the voltage may be manually adjustable, for example by adjusting a gap width of a spark gap. Example spark gaps devices usable to implement the overvoltage protection device 114 are described in detail in U.S. pat. No. 9,60,441, U.S. Pat. No. 11,038,347, and U.S. Patent Pub. No. 2020/0106262, the disclosures of each of which are hereby incorporated by reference in their entireties.

In the example shown, a switch assembly is electrically connected in parallel with the DC blocking component 112 and the overvoltage protection device 114 between the transformer neutral 14 and ground connection 18. The switch assembly may be implemented, for example, as a direct current switch assembly 101.

The direct current switch assembly 101 includes a direct current switch 102 encased within a switch housing 103. The direct current switch 102 is actuated between an open position and a closed position by sensing and control electronics 150. In example embodiments, the direct current switch assembly 101 may be constructed using one or more direct current circuit breakers, a disconnect switch, or some other type of switch.

The sensing and control electronics may receive signals from a detector 160, as well as determining a current between the transformer neutral 14 and ground connection 18 via an electrical connection at a shunt resistor 104 electrically connected between the direct current switch assembly 101 and the ground connection 18. An example detector 160 is described in U.S. Pat. No. 8,773,107, the disclosure of which is hereby incorporated by reference in its entirety. Operation of the sensing and control electronics 150 is described in greater detail in U.S. Pat. Nos. 10,199,821, 10,931,096, and U.S. Patent Pub. No. 2022/0254565, the disclosures of each of which are hereby incorporated by reference in their entireties.

In some examples, by default the direct current switch assembly 101 will maintain direct current switch 102 in a closed position until detection of a potentially harmful event, referred to herein as a protection event. Such a protection event may include, for example, sensing of an electromagnetic pulse or other signal via a detector 160 that may indicate a future induced current on a power grid above a predetermined, potentially damaging threshold. A protection event may also include sensing a geomagnetically induced current (GIC) above a predetermined threshold, for example via an input at the shunt resistor 104 as described above, or utilizing a different DC current measuring device. Details regarding such thresholds and potential triggering events are described in the patents and publications previously incorporated by reference. In example embodiments, the direct current switch 102 is selected such that it has a voltage withstand rating that is high, but which may not be as high as the potential voltage difference between the transformer neutral 14 and ground connection 18. For example, the direct current switch 102 may have an impulse withstand voltage rating of up to 12 kV, and perhaps only 1000V or 1500 V for a prolonged voltage. Other types or ratings of direct current switches may be used as well.

In the example shown, the direct current switch assembly 101 maintains direct current switch housing 103 in a position that is electrically isolated from ground connection 18. That is, there is, in this embodiment, no electrical connection formed between housing 103 and another circuit or ground. As noted previously, maintaining the direct current switch housing 103 electrically isolated from the ground connection 18 allows for a higher voltage withstand of the direct current switch assembly 101 than its standard rating, thereby potentially reducing the need for, and in some cases eliminating, an alternating current switch used to protect in the event of higher voltage differences between the transformer neutral 14 and ground connection 18 after such switches are in an open position. For example, a direct current switch 102 having a voltage withstand rating of up to 12 kV may, when isolated, be operable at prolonged voltages up to or exceeding 20 kV, or as high as up to or exceeding 22 kV. It is noted that, when used in conjunction with an appropriately selected overvoltage protection device 114, relative thresholds may be selected such that a voltage withstand of the direct current switch assembly 101 may not be reached, since the spark threshold of such an overvoltage protection device 114 may be selected to be lower than the voltage withstand.

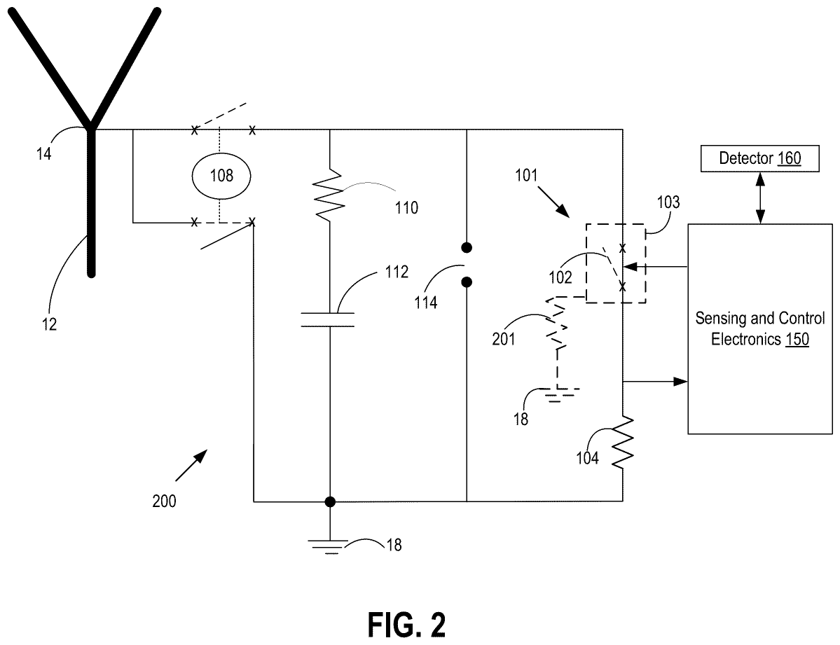

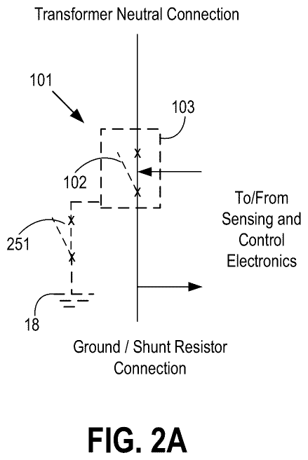

Now referring to FIGS. 2-5, various alternating embodiments of a direct current switch assembly are shown that may be used in a protection circuit as described herein.

In FIG. 2, a transformer protection circuit 200 is shown in which the direct current switch assembly 101 includes the direct current switch 102 and the direct current switch housing 103, but the direct current switch housing 103 is electrically connected to ground via a resistor 201. In the example shown, the connection between the direct current switch housing 103 is illustrated as providing a connection via ground connection 18, however any connection to ground could be used. Additionally, in examples, the direct current switch housing 103 may be excluded.

In this example, the resistor 201 is selected to have a resistance sufficiently high such that the direct current switch housing 103 is effectively isolated from the ground connection 18. For example, the resistor 201 may have a resistance of a few ohms to 1 MOhm or greater. In some examples, a resistor of greater than 1000 ohms is used. Other resistances may be used as well.

In FIG. 2A, an alternative version of a direct current switch assembly may be integrated within the protection circuit 100. In this example, a direct current switch assembly 151 includes the direct current switch 102 and direct current switch housing 103, but the direct current switch housing 103 is electrically connected to ground via a switch 251, rather than resistor 201. The switch 251 may be a normally-closed switch, and may be electrically actuated to open in response to various events, such as the protection events mentioned above. For example, one or both of the direct current switch 102 and the switch 251 may be configured to be actuated to an open position in the event the sensing and control electronics 150 detects one or more of an electromagnetic pulse (e.g., via detector 160), a current above a predetermined threshold between the transformer neutral and the ground connection, a voltage above a voltage threshold between the transformer neutral and the ground, or a harmonic signal detected on at least one phase of the transformer that exceeds a signal threshold. In various embodiments, the thresholds for actuation of such switches may be configurable, and may be at the same threshold, or at different thresholds. In some examples, switch 251 may be configured to be opened prior to actuation of the direct current switch 102, e.g., at lower thresholds and/or different test parameters.

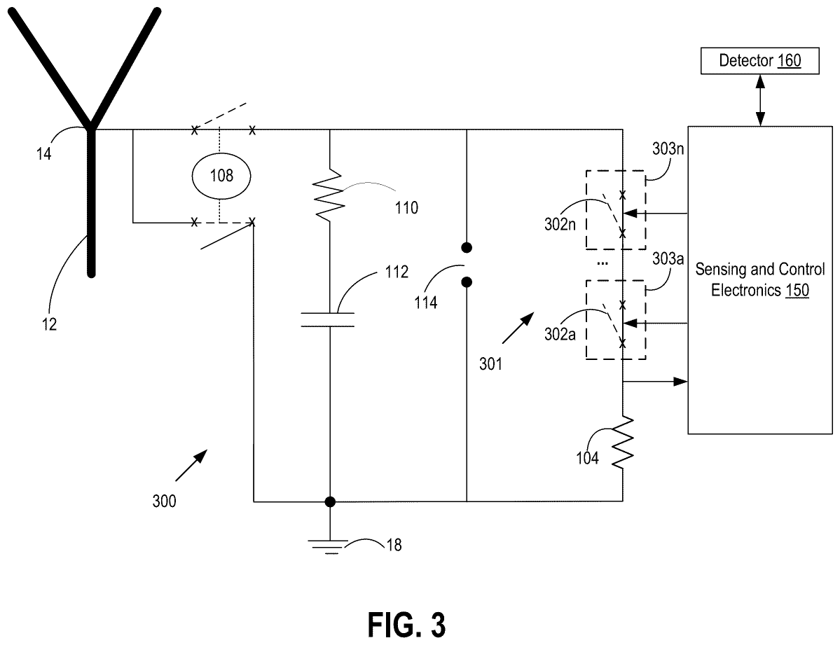

In FIG. 3, a protection circuit 300 generally corresponds to protection circuit 100 described above in conjunction with FIGS. 1-2. However, in this case, a direct current switch assembly 301 is used. The direct current switch assembly 301 may include a plurality of direct current switches 302a-n electrically connected in series with each other. Each of the direct current switches 302a-n may have an associated electrical switch housing 303a-n, respectively. In some examples, each of the electrical switch housings 303a-n are electrically isolated from ground.

In this example, each of the direct current switches 302a-n may be actuated at the same time by the sensing and control electronics 150. This may be via simultaneous actuation signals, or by being connected to the same actuation signal line.

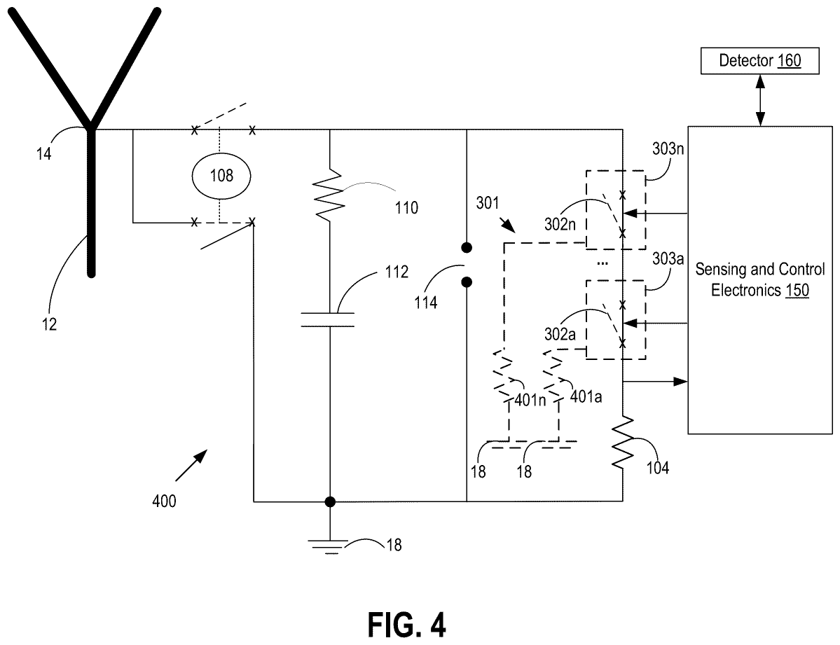

FIG. 4 illustrates a further example transformer protection circuit 400 in accordance with a further embodiment of the present disclosure. In this example, a direct current switch assembly 301 is used. In this example, one or more resistors 401a-n may be electrically connected between each of the electrical switch housings 303a-n and a ground connection 18. In various implementations, separate resistors may be used for each direct current switch housing, or a common one or more resistors may be electrically connected to a common connection across the direct current switch housings.

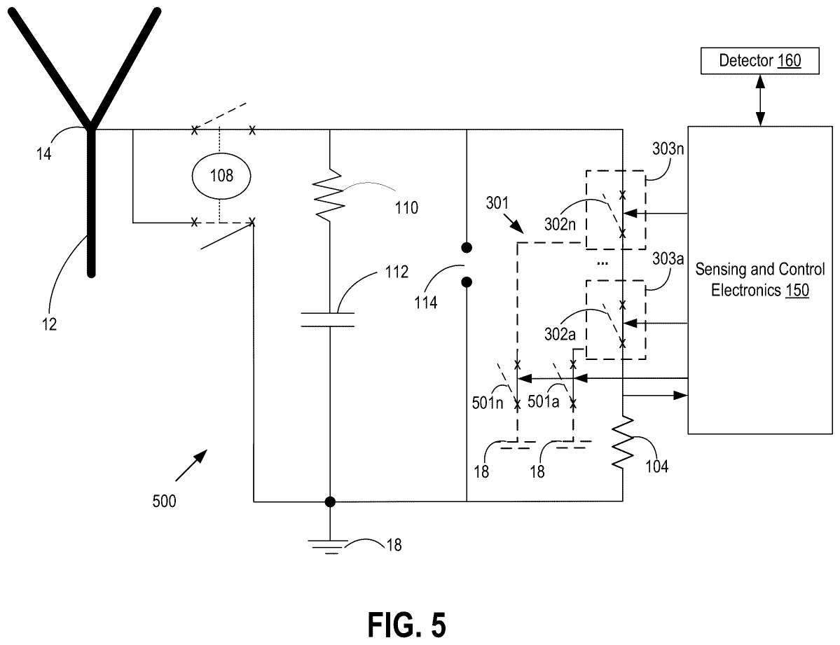

FIG. 5 illustrates a still further example transformer protection circuit 500. In this example, direct current switch assembly 301 is used; however, aspects of this configuration may be used in conjunction with direct current switch assemblies 101, 151 as well. In this example, each of the direct current switches is electrically connected to a separate switch 501. The switch 501 may be implemented as an electrical switch, optionally also actuated by the sensing and control electronics 150. In this example, when a protection event is detected, the sensing and control electronics 150 may actuate the direct current switches 302a-n, moving those switches from a closed position to an open position. The sensing and control electronics 150 may receive a signal from a detector 160 indicating a future induced current on a power grid, which may correspond to an induced voltage when one or more of the direct current switches 302a-n are open. This could potentially exceed a voltage withstand rating of one or more of the direct current switches 302a-n. In examples, a normally closed switch 501 may be actuated to an open position, thereby isolating the case of one or more of the direct current switches 302a-n from ground (e.g., disconnection from ground connection 18). The sensing and control electronics 150 may then detect a voltage at the transformer neutral. Upon the voltage reaching a predetermined threshold (which may be a different predetermined threshold then the current threshold used to determine whether to open the switches 302a-n), a separate actuation signal may be sent to open a normally closed switch 501, thereby electrically isolating the switch housings 303a-n from the ground connection 18. In further examples, separate switches 501 may be used for each electrical switch housing 303a-n, thereby allowing for separate determinations and separate isolation of each housing by the sensing and control electronics. For simplicity only, a single switch 501 is depicted.

Referring to FIGS. 1-5 generally, it is noted that a variety of advantages are achieved by way of the protection circuits described herein. For example, at the outset, protection circuits may be constructed at lower cost and with simplified supply, due to a reduced number and type of parts. Installation is also significantly easier, since the direct current switch is generally smaller and less complex to install than an alternating current circuit breaker. Furthermore, overall logic used to actuate switches may be simplified, since all direct current switches may be actuated concurrently, whereas in prior designs a sequenced operation of opening circuit breakers (first DC, then AC) was performed. Still further, the embodiments described in FIGS. 3-5 provide additional redundancy of shut off, while providing both sufficient short-term impulse voltage withstand as well as sufficient long-term voltage withstand, while retaining the practical ability of a direct current switch to break either alternating current or direct current. Other advantages are apparent as well, in accordance with the present disclosure.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A protection circuit electrically connected to a transformer neutral of a power grid transformer, the protection circuit comprising:
a direct current (DC) blocking component electrically connected between the transformer neutral and a ground connection;
a direct current switch assembly positioned in parallel with the direct current blocking component between the transformer neutral and the ground connection, the direct current switch assembly including at least one direct current switch having a switching element enclosed by a conductive housing, the switching element being electrically controllable between a closed position and an open position;
wherein the conductive housing is electrically isolated from the ground connection.

2. The protection circuit of claim 1, wherein the direct current switch assembly includes a plurality of direct current switches electrically connected in series with each other.

3. The protection circuit of claim 2, wherein the plurality of direct current switches each include a switching element enclosed by a conductive housing, and wherein the conductive housing of one or more of the plurality of direct current switches is electrically isolated from the ground connection.

4. The protection circuit of claim 3, wherein the conductive housing of each of the plurality of direct current switches is electrically isolated from the ground connection.

5. The protection circuit of claim 4, further comprising a resistive element electrically connected between each conductive housing of each of the plurality of direct current switches and the ground connection.

6. The protection circuit of claim 1, further comprising a resistive element electrically connected between the conductive housing and the ground connection.

7. The protection circuit of claim 1, wherein in the closed position, a circuit path is formed between the transformer neutral and the ground bypassing the DC blocking component.

8. The protection circuit of claim 1, further comprising sensing and control electronics operatively connected to an actuation input of the direct current switch assembly, the sensing and control electronics configured to actuate the direct current switch assembly from a normally closed position to an open position in response to detection of a current above a predetermined threshold between the transformer neutral and the ground connection.

9. The protection circuit of claim 1, wherein the direct current blocking component includes at least one capacitor.

10. The protection circuit of claim 1, further comprising a switching element electrically connected between the conductive housing and the ground connection.

11. The protection circuit of claim 1, wherein opening the switching element disconnects the conductive housing from the ground connection, and wherein the switching element is maintained in a normally-closed position.

12. The protection circuit of claim 11, wherein the switching element is opened in response to detection of an electrical event, the electrical event being at least one of:
an electromagnetic pulse;
a current above a predetermined threshold between the transformer neutral and the ground connection;
a voltage above a voltage threshold between the transformer neutral and the ground; or
a harmonic signal detected on at least one phase of the transformer that exceeds a signal threshold.

13. A protection circuit electrically connectable between a transformer neutral of a power grid transformer and a ground connection, the protection circuit comprising:
a direct current (DC) blocking component electrically connectable between the transformer neutral and the ground connection;
a direct current switch assembly electrically connectable in parallel with the direct current blocking component, the direct current switch assembly including a plurality of direct current switches operatively connected in series with each other, each of the plurality of direct current switches having a switching element, the switching element of each of the plurality of direct current switches being electrically controllable between a closed position and an open position.

14. The protection circuit of claim 13, wherein the switching element of each of the plurality of direct current switches is enclosed by a conductive housing.

15. The protection circuit of claim 13, wherein the switching element of each of the plurality of direct current switches is enclosed by a separate conductive housing, and wherein at least one conductive housing is electrically isolated from the ground connection.

16. The protection circuit of claim 13, further comprising sensing and control electronics operatively connected to control the direct current switch assembly.

17. The protection circuit of claim 16, wherein the sensing and control electronics is configured to actuate each of the plurality of direct current switches in response to detection of a protection event.

18. The protection circuit of claim 17, wherein the protection event comprises a geomagnetically induced current on a power grid to which the transformer is connected, wherein the geomagnetically induced current is above a predetermined threshold.

19. The protection circuit of claim 17, wherein the protection event comprises an electromagnetic pulse event that induces a current above a predetermined threshold at the transformer neutral.

20. The protection circuit of claim 13, further comprising at least one resistor electrically connected between a conductive housing of each of the plurality of direct current switches and a ground connection.

21. The protection circuit of claim 13, further comprising an overvoltage protection device electrically connected between the transformer neutral and ground in parallel with the direct current blocking component and the direct current switch assembly.

22. The protection circuit of claim 21, wherein the overvoltage protection device has a voltage threshold higher than a rated voltage withstand of any one of the plurality of direct current switches but lower than a tested voltage withstand of the direct current switch assembly.

23. The protection circuit of claim 13, further comprising a switch operatively connected between a conductive housing of at least one of the plurality of direct current switches and a ground.
